(19) United States
(12) Patent Application Publication
(10) Pub. No.: US 2006/0116266 A1
(43) Pub. Date: Jun. 1, 2006

(54) Helium tracer gas bags and related method

(75) Inventors: Brock Lape, Schenectady, NY (US); Roderick Mark Lusted, Niskayuna, NY (US); Stephen Lawrence Burroughs, Schuylerville, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/305,038

(22) Filed: Dec. 19, 2005

Related U.S. Application Data
(62) Division of application No. 10/604,552, filed on Jul. 30, 2003.

(51) Int. Cl. B31B 37/00

(52) U.S. Cl. 493/186

(57) ABSTRACT

A tracer gas bag for a stator bar leak test comprising a polymer sheet having four marginal edges, each covered with a strip of tape with exposed adhesive thereon.

### BACKGROUND OF THE INVENTION

This invention relates generally to turbine generator construction and specifically, to a bag construction used to encapsulate a stator bar for collection of stray helium gas in a test for leaks.

Current gas bags used during helium tests are time consuming to manufacture, and difficulties are experienced subsequently during both installation and removal. The bags require multiple materials, thus increasing the chances for false positive leaks and poorly sealed bags. More specifically, the current practice is to manually fabricate the bags on-site from various plastics or polymers. The bags are then hand cut, and strips of duct tape applied along marginal edges for securing the side panels. The disadvantages include the tape sticking to itself, disallowing the bag to be used and often creating a poor seal to the stator bars. In addition, residue may remain on the stator bar from the adhesive. The current practice is also labor intensive, utilizing manpower that could be better employed, for example, for wrapping the stator bars.

### BRIEF DESCRIPTION OF THE INVENTION

The present invention provides a pre-cut and pre-measured tracer gas bag that will comply with all generator stator bar designs, and that allows for quick attachment. The tracer gas bags in accordance with this invention will improve the reliability of the helium leak test, decrease the chances for helium leaks escaping and giving false positives, and will reduce installation time and cost.

In the exemplary embodiment of the invention, a two-sided adhesive tape is laminated to the outer-edges of a single poly sheet, preferably along all four marginal edges of the sheet. The bag is formed simply by folding the sheet over on itself and sealing the marginal edges via the double-sided adhesive. When applied over the ends of one or more stator bar ends, some edge portions of the sheet will seal directly to the stator bar ends while other edge portions will seal directly to each other, depending on the stator bar end configuration. The result is a sealed enclosure about the one or more stator bar ends that is suitable for gas leakage tests.

In another embodiment, wider strips of single-sided adhesive are applied to the opposite short ends of the sheet. In one example, four inch wide tape is applied to the ends, with a one inch overlap. The adhesive side is covered with a conventional peel strip and, when removed, the sheet may be folded over itself and the stator bar end(s) as described above. The use of wider tape on opposite ends of the bag effectively lengthens the bag.

In use, the bag is sealed about one or more stator bar ends and, after a predetermined period of time, a gas detector probe is inserted through the bag to detect any leakage of gas from the stator ends. After the test is completed, the probe is withdrawn and the hole sealed by another strip of tape. The bag may be re-used and the taped hole can be uncovered for later re-insertion of the probe.

Thus, in one aspect, the present invention relates to a tracer gas bag for stator bar testing comprising a polymer sheet folded over itself and joined about at least the peripheral edges by a two-sided adhesive tape.

In another aspect, the invention relates to method of constructing a tracer gas bag for a stator bar leak test comprising a) providing a thin sheet for forming first and second faces of the gas bag; b) applying a double sided adhesive tape along marginal edges of at least three sides of the sheet; and c) folding the sheet about a stator bar end and sealing the marginal edges utilizing the strips of adhesive tape.

The invention will now be described in connection with the drawings described below.

### BRIEF DESCRIPTION OF THE DRAWINGS

FIG. 1 is a top plan view of a tracer gas bag in accordance with an exemplary embodiment of the invention;

FIG. 2 is a top plan view of a tracer gas bag in accordance with another embodiment of the invention; and

FIG. 3 is a simplified perspective view illustrating the application of the bag to a stator bar end.

### DETAILED DESCRIPTION OF THE INVENTION

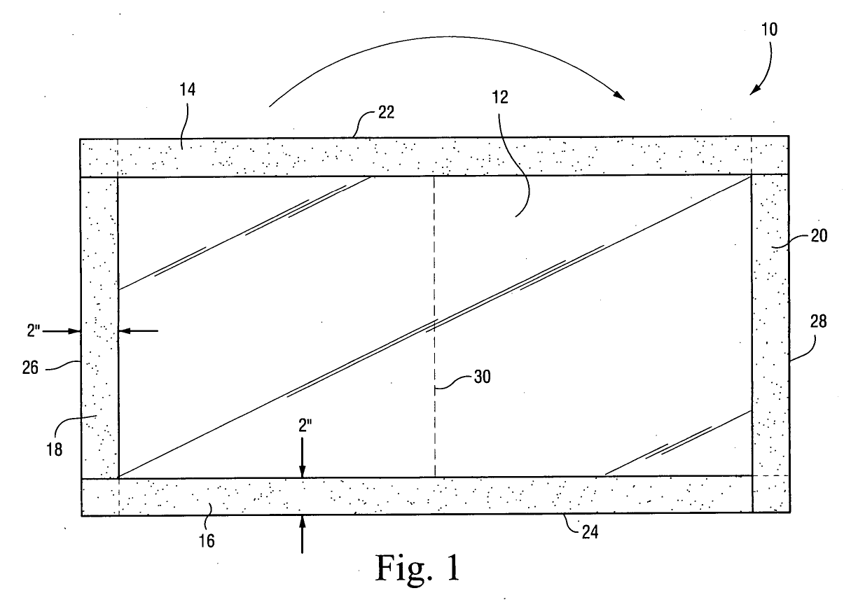

With reference to FIG. 1, the tracer gas bag 10 is formed from a single pre-cut polymer sheet or film 12. The flexible sheet 12 is relatively heavy gauge and may be transparent. Strips of double-sided adhesive 14, 16, 18 and 20 are adhered to the sheet along the four marginal edges 22, 24 26 and 28 of the sheet. Protective peel strips (not shown) may be applied over the exposed adhesive strips until the bag is ready for use. With the double-sided adhesive strips applied as shown in FIG. 1, it will be appreciated that the sheet 12 may be folded generally over itself about an imaginary fold line 30 and the marginal edges pressed together to form a sealed enclosure or bag. The preferred application, however, will be described further below.

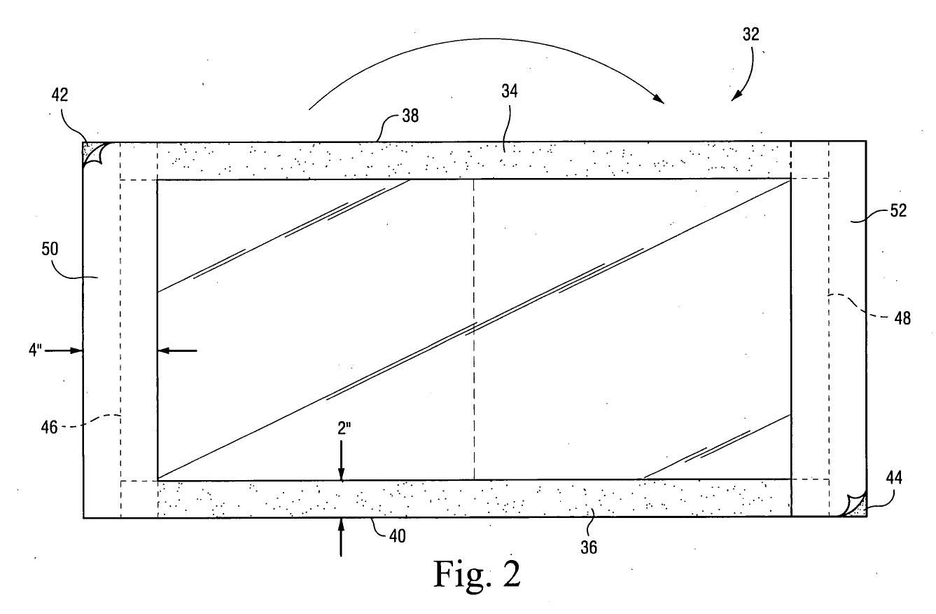

In still another embodiment, best seen in FIG. 2, a bag 32 is formed by adding double-sided adhesive strips 34, 36 along the marginal edges 38, 40 of the longer sides, and a pair of four inch wide, single-sided adhesive strips 42, 44 are applied along the marginal edges 46, 48 of the opposite ends or shorter sides of the sheet. Conventional peel strips 50, 52 are shown to cover the exposed adhesive on strips 42, 44 and it will be appreciated that similar peel strips may be applied over the exposed adhesive on strips 34, 36 until the bag is ready for use. By applying the end strips with a one inch overlap, the length of the bag can be effectively extended by six inches.

In the exemplary embodiments, the poly film layers or sheets may be comprised of polyvinyl chloride film, but it will be appreciated that other suitable materials may be used. The double-sided adhesive may be of any suitable kind, for example, an acrylic adhesive on a polypropylene substrate, synthetic rubber and resin type adhesives on a low density polyethylene substrate, or other suitable adhesive tape. The film or sheet thickness may be about 8 mil, but may vary as required for different applications. It will also be appreciated that the overall dimensions of the bag may vary as well. One suitable size for the sheet 12 is about 24 to about 36 inches in length and 12-18 inches in width. In one example, the bag is 30 inches in length by 18 inches in width.

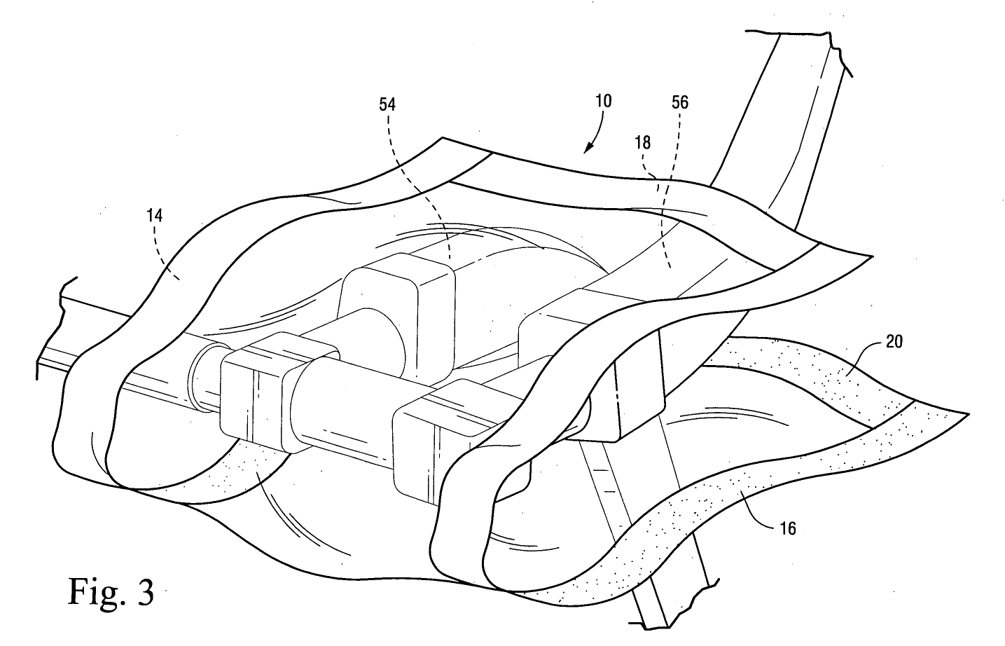

Turning now to FIG. 3, it will be appreciated that, in use, the open sheet 10 (prior to folding) is applied over a pair of stator ends 54, 56 and folded such that two opposite sides of the bag can be sealed by engagement of the adhesive tape strips 14, 16, 18, 20 about the stator end and to each other, thus creating a sealed enclosure around the stator ends. It should be understood, however, that the stator bar ends 54, 56 could be wrapped individually if desired. The specific wrapping and sealing technique may also vary according to specific applications. After a predetermined period of time (several hours, for example), a gas detection probe is inserted through the sheet 12 and into the enclosed area. If any gas (helium, for example) has leaked into the bag, it will be detected by the probe. The probe is then withdrawn and the opening sealed with tape. The bag may be re-used with subsequent access to the opening gained by peeling off the tape.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1-8. (canceled)

9. A method of constructing a tracer gas bag for a stator bar leak test comprising:
a) providing a pre-cut, flexible poly sheet for forming first and second faces of the gas bag;
b) applying a double sided adhesive tape along four marginal edges of said sheet; and
c) folding said sheet about at least one stator bar end and sealing said marginal edges to portions of said at least one stator bar end and portions to each other, utilizing said strips of adhesive tape.

10. The method of claim 9 wherein said two-sided adhesive tape comprises an acrylic adhesive on a polypropylene substrate.

11. The method of claim 9 wherein the polymer sheets comprise a polyvinyl chloride film.

12. The method of claim 9 wherein said two-sided adhesive tape has a width of about two inches.

13. The method of claim 9 wherein said polymer sheet has a thickness of about 8 mil.

14. The method of claim 13 wherein said polymer sheets have a length of about 24-36 inches and a width of about 12-18 inches.

15. The method of claim 9 wherein said two-sided adhesive tape comprises an acrylic adhesive in a polypropylene substrate and the polymer sheets comprise a polyvinyl chloride film.
